(19) United States
(12) Patent Application Publication
(10) Pub. No.: US 2015/0269861 A1
(43) Pub. Date: Sep. 24, 2015

(54) System and Method for Using Pilot Controllable Discretionary Operational Parameters to Reduce Fuel Consumption in Piloted Aircraft

(71) Applicants: Rebecca Rose Shaw, Lailua, HI (US); Thomas J. Shaw, Frisco, TX (US)

(72) Inventors: Rebecca Rose Shaw, Lailua, HI (US); Thomas J. Shaw, Frisco, TX (US)

(21) Appl. No.: 14/667,305

(22) Filed: Mar. 24, 2015

Related U.S. Application Data
(60) Provisional application No. 61/969,639, filed on Mar. 24, 2014.

(51) Int. Cl. G09B 9/08

(52) U.S. Cl. CPC G09B 9/08

(57) ABSTRACT

A system and method for using pilot-controllable discretionary operational parameters to reduce fuel consumption in piloted aircraft, for training pilots in use of the system of the invention, and for comparatively rating a particular pilot in relation to plurality of pilots as to the ability to reduce aircraft fuel consumption through the utilization of pilot controllable discretionary operational parameters.

### FIELD OF THE INVENTION

This invention relates to a system and method for using operational parameters to reduce fuel consumption in piloted aircraft. One aspect of the invention relates to the identification and use of functions or actions that can be initiated by or are otherwise within the discretion-and-control of an aircraft pilot to reduce fuel consumption in piloted aircraft. Another aspect of the invention relates to training pilots in the use of pilot controllable discretionary operating parameters (“PCDOP”) to reduce aircraft fuel consumption. The system and method of the invention are also useful for rating pilot performance and efficiency according to the relative skill and abilities of pilots to use PCDOP to reduce fuel consumption in piloted aircraft.

### DESCRIPTION OF RELATED ART

Many parameters of manned aircraft flight are generally recognized to be outside the control of aircraft pilots. Such parameters can include, for example, aircraft and engine type, engine efficiency, fuel tank capacity, payload (excluding fuel weight), destination, departure time, ground holds, departure holds, weather holds, departure and approach patterns, weather conditions, and the like. Some flight parameters such as route or altitude can be adjusted during flight only after a pilot has requested and obtained clearance from air traffic control. Other operational parameters (PCDOP) of an aircraft are routinely subject to pilot control and can be adjusted within operational limits by a pilot either prior to or during flight. An example of a pilot discretionary operating parameter that is often adjustable within operational limits by a pilot prior to flight is the pounds of fuel loaded, which directly affects both the gross takeoff weight of the aircraft and the range that can be flown, but will be affected by other factors such as engine efficiency and weather conditions at altitude.

No matter whether aircraft are used for private aviation, freight transport, national security, or for other purposes, fuel consumption is known to be a principal cost of piloted aircraft operation, and fleet managers of such aircraft are typically interested in reducing fuel consumption to hold down operating costs. Many instrumentation and control systems have previously been developed and disclosed to automate and improve aircraft operation, safety and efficiency. Aircraft and aircraft engines have been improved to reduce fuel consumption. Aircraft design, materials and construction techniques have been improved to reduce aircraft weight and increase passenger occupancy and payloads with the objective of reducing fuel costs per passenger mile or pound of payload.

A system and method are nevertheless needed that are particularly directed to the identification, monitoring and use of PCDOP for reducing fuel consumption in piloted aircraft and for the purpose of evaluating and rating pilot proficiency and performance in the management and implementation of PCDOP to improve operational efficiencies and further reduce aircraft fuel consumption.

### SUMMARY OF THE INVENTION

A system and method are disclosed here that are useful for identifying, monitoring, collecting, receiving, analyzing, normalizing, comparing, reconfiguring, formatting, displaying, and transmitting or recording pilot performance data pertaining to PCDOP with the objective of reducing fuel consumption in piloted aircraft.

According to one embodiment of the invention, a system and method are disclosed for training pilots in the use of PCDOP to reduce aircraft fuel consumption. By way of example and without limitation, PCDOP can include flight parameters such as: altitude; attitude; heading; throttle position; airspeed; rates and slope of climb and descent; timing and duration of control surface deployment for flaps, slats, ailerons and rudders; retraction and deployment of landing gear; and the like. Other parameters that are not strictly controllable by a pilot, may also be important informational inputs to be supplied to the pilot as auxiliary data for the pilot to use in making decisions about pilot controllable parameters that will affect fuel consumption by the aircraft. For example, a pilot facing headwinds along a particular flight route may request, while using the system and method of the invention, auxiliary data such as real-time or stored historical data on wind direction and velocity at various altitudes along the route for use in assessing whether to request a change in altitude or a change in heading that is anticipated to reduce overall fuel consumption and flight duration even though it may increase the number of miles flown.

According to another embodiment of the invention, a system and method are disclosed for evaluating and rating pilot performance and proficiency in the use of PCDOP to reduce aircraft fuel consumption. The evaluation and rating aspect of the invention can be selectively directed to comparing a pilot's performance in the management of PCDOP over a defined time interval or number of flights in relation to the performance of a large group of other pilots, taken as a whole; or in relation to a defined benchmark or targeted objective such as pounds of fuel per pound of payload per minute flown; or in relation to a pilot's own prior performance over a prior interval. If desired, a normalized value computed from a large sample of empirical PCDOP data based upon and collected from many flight segments can be manipulated or adjusted to eliminate or substantially reduce the effects on fuel consumption of other “nondiscretionary” factors outside of the pilot's control.

According to another embodiment of the invention, a method for training pilots in the use of pilot-controlled discretionary operational parameters (PCDOP) to reduce fuel consumption in piloted aircraft is disclosed comprising: identifying to a pilot at least one PCDOP affecting fuel consumption in piloted aircraft; monitoring use by the pilot of the at least one PCDOP in maneuvering a piloted aircraft; and comparing use by the pilot of the at least one PCDOP in maneuvering the piloted aircraft to a predetermined benchmark value for the at least one PCDOP to reduce fuel consumption in the piloted aircraft.

According to another embodiment of the invention, a system is disclosed that embodies a computer readable medium storing a computer program that when executed causes a computer to perform the steps of: identifying to an aircraft pilot at least one pilot-controllable discretionary operational parameter (PCDOP) affecting fuel consumption by the aircraft and a range of operational limits for the at least one PCDOP and aircraft that are consistent with reducing fuel consumption by the aircraft; displaying to the pilot in substantially real time a current operational level for the at least one PCDOP in relation to the range of operational limits for the at least one PCDOP and aircraft that are consistent with reducing fuel consumption by the aircraft; receiving from the pilot at least one input of the at least one PCDOP in maneuvering a piloted aircraft; and comparing use by the pilot of the at least one PCDOP in maneuvering the piloted aircraft in relation to the range of operational limits and in relation to the aircraft fuel consumption.

### BRIEF DESCRIPTION OF THE DRAWINGS

The apparatus of the invention is further described and explained in relation to the following drawings wherein:

FIG. 1 is a simplified diagrammatic representation one preferred embodiment of a system of the invention.

### DESCRIPTION OF A PREFERRED EMBODIMENT

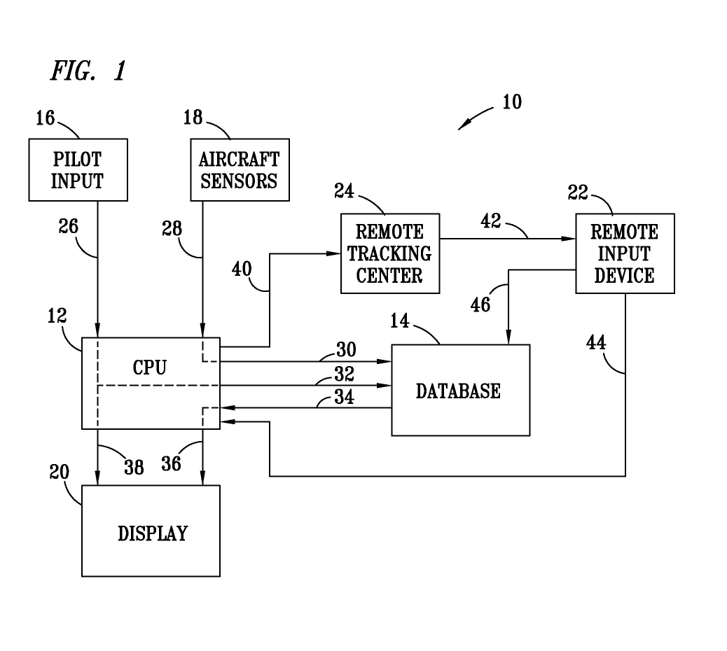

Referring to FIG. 1, one system 10 of the invention comprises at least one CPU 12 including at least one programmable logic controller that is configured to receive flight data for PCDOP from one or more databases 14 residing in one or more electronic storage devices that can be resident in system 10 as shown by arrow 34 or from a remote input device 22 as shown by arrow 44. Depending upon the basis chosen for a comparative evaluation and rating, the flight data can desirably include data for PCDOP for a large sample, most preferably a statistically significant sample, of flight segments previously flown by many different pilots or by a particular pilot whose performance is being evaluated. Additionally, the PCDOP data will desirably be indexed and searchable by pilot, aircraft type, engine type, payload, pounds of fuel consumed, elapsed flight time, and other factors of interest in a particular context to facilitate comparison of fuel consumption during the flights or flight segments under consideration. The flights or flight segments upon which a particular evaluation is based can selectively extend from takeoff to touchdown between two identified locations, or can optionally focus on incremental portions of a flight path or route of travel. Such incremental portions might include, for example: from takeoff roll to an altitude of 10,000 feet; from takeoff to 50 miles out; from 50 miles out to landing; from 50 miles after takeoff to 50 miles from landing; or time periods such as the first 15 minutes of flight, or time flown at cruising altitude.

During the data collection process, CPU 12 (which can include a plurality of CPUs disposed at various locations) will desirably receive pilot and aircraft identification data and raw data for PCDOP from pilot inputs 16 and aircrafts sensors 18 as indicated by arrows 26, 28, respectively, for each of a plurality of flights. The raw data are desirably processed, configured and formatted for transmission to and storage in database 14 as indicated by arrows 32 and 30, respectively. Optionally, CPU 12 can comprise a computer readable medium storing a computer program that when executed causes a computer to identifying to an aircraft pilot at least one pilot-controllable discretionary operational parameter (PCDOP) affecting fuel consumption by the aircraft and a range of operational limits for the at least one PCDOP and aircraft that are consistent with reducing fuel consumption by the aircraft. It should be understood and appreciated by those of skill in the art reading this disclosure that FIG. 1 is greatly simplified in that it does not purport to show other components of system 10 such as, for example, transducers, amplifiers, transmitters, antennas, receivers, power supplies, switches, filters, firewalls, gates, compilers, and the like, that are required to fully implement system 10 of the invention. Such ancillary devices are believed to be well known to those of skill in the art and commercially available for use in such applications.

Empirical data collected in database 14 can include without limitation any flight data for PCDOP that is considered by the user to be a potentially significant factor contributing to fuel consumption in piloted aircraft. Prior to or during use of such data for one or more of the purposes stated above, the data can be exported from database 14 back to the same or a different CPU 12 as indicated by arrow 34 to process, normalize, transform, adjust or otherwise manipulate it to produce or determine values that are representative of the factors under consideration in characterizing, evaluating or comparatively rating a pilot's use of PCDOP to manage, control or reduce fuel consumption in a piloted aircraft. Different flight segments may require independent analysis with respect to any restrictions on operation (for example, noise abatement, minimum altitude over populations, minimum flap angle, gear down altitude, and the like that are imposed by regulation or by air traffic control) during particular times of operation. The processed data can then be returned to database 14 as indicated by arrows 32, 30 for storage in processed form or can be selectively presented in spreadsheet, graphical or tabular form, or downloaded to printers or other storage media and devices (not depicted in FIG. 1) as desired. Such presentations can be used for instructional or evaluative purposes as desired.

According to another embodiment of the invention, system 10 can optionally include as one display mode a presentation to a pilot in the aircraft cockpit (or, alternatively, in a flight simulator) of real time flight data for PCDOP in relation to a benchmark value or historical norm that is determined as discussed above. Such a display can optionally include, for example, a real time fuel consumption rate or percentage of fuel consumed during a relevant stage of the flight as compared to a predetermined benchmark. This can be implemented in any of many different ways, including, for example, graphical overlays using different colors or symbols, or as digital images. Alternatively, an indicator of the fuel burn rate or percentage of fuel consumed can be made to flash if it exceeds a predetermined benchmark for that stage of a flight under the same or similar conditions. One objective of providing real time feedback to a pilot is to enable the pilot to consider during a flight those discretionary actions within his control that can improve his use of PCDOP to reduce fuel consumption.

According to another embodiment of the invention, the system can include a remote tracking center 24 that receives actual real time flight data from CPU 12 as indicated by arrow 40, which data can be stored remotely from database 14 and/or forwarded to a remote access and input device 22 as shown by arrow 42. Remote access and input device 22 can also be part of the subject system and can be used, for example, to dynamically update database 14 as indicated by arrow 46 or function as a ground-based flight center that can selectively transmit flight inputs directly to CPU 12 as indicated by arrow 44. Such flight inputs can include, for example, informational, instructional or override commands that are also formatted and displayed by display 20 from inputs received as indicated by arrows 36, 38.

Other alterations and modifications of the invention will likewise become apparent to those of ordinary skill in the art upon reading this specification in view of the accompanying drawings, and it is intended that the scope of the invention disclosed herein be limited only by the broadest interpretation of the appended claims to which the inventor is legally entitled.

What is claimed is:

1. A system for use in evaluating and rating the relative ability of an aircraft pilot to use pilot-controlled discretionary operational parameters (PCDOP) to reduce fuel consumption in a piloted aircraft, the system comprising:
at least one CPU configured to receive, process and format data comprising aircraft flight data and pilot input data for a plurality of PCDOP and to index the data according to a plurality of predetermined fields including pilot identification, aircraft identification and fuel consumption;
at least one database operationally linked with at least one CPU to send and receive processed data between them; and
at least one display device configured to receive and display processed data received from the at least one CPU; wherein
the processed data further comprises comparison data relating the fuel consumption for a particular pilot and aircraft in relation to a benchmark fuel consumption level for the aircraft.

2. The system of claim 1 wherein at least one PCDOP is selected from the group consisting of: altitude; attitude; heading; throttle position; airspeed; rate and slope of climb and descent; timing and extent of control surface deployment for flaps, slats, ailerons and rudders; and retraction and deployment of landing gear.

3. The system of claim 1, further comprising an electronic storage device configured to receive and store the comparison data for later recall.

4. The system of claim 1, further comprising a printer configured to receive and print the comparison data.

5. The system of claim 1 wherein the benchmark fuel consumption level is derived from a plurality of prior flights by the same pilot in the same type aircraft under similar conditions.

6. The system of claim 1 wherein the benchmark fuel consumption level is derived from a plurality of prior flights by different pilots in the same type aircraft under similar conditions.

7. The system of claim 1 wherein the benchmark fuel consumption level is a predetermined, targeted objective.

8. The system of claim 1, further comprising a remote tracking center.

9. The system of claim 1, further comprising a remote input device.

10. A method for evaluating and rating pilot proficiency through use of the system of claim 1.

11. A method for training pilots in the use of pilot-controlled discretionary operational parameters (PCDOP) to reduce fuel consumption in piloted aircraft comprising:
identifying to a pilot at least one PCDOP affecting fuel consumption in piloted aircraft;
monitoring use by the pilot of the at least one PCDOP in maneuvering a piloted aircraft; and
comparing use by the pilot of the at least one PCDOP in maneuvering the piloted aircraft to a predetermined benchmark value for the at least one PCDOP to reduce fuel consumption in the piloted aircraft.

12. A computer readable medium storing a computer program that when executed causes a computer to perform the steps of:
identifying to an aircraft pilot at least one pilot-controllable discretionary operational parameter (PCDOP) affecting fuel consumption by the aircraft and a range of operational limits for the at least one PCDOP and aircraft that are consistent with reducing fuel consumption by the aircraft;
displaying to the pilot in substantially real time a current operational level for the at least one PCDOP in relation to the range of operational limits for the at least one PCDOP and aircraft that are consistent with reducing fuel consumption by the aircraft;
receiving from the pilot at least one input of the at least one PCDOP in maneuvering a piloted aircraft; and
comparing use by the pilot of the at least one PCDOP in maneuvering the piloted aircraft in relation to the range of operational limits and in relation to the aircraft fuel consumption.
